(19) United States
(12) Patent Application Publication
(10) Pub. No.: US 2010/0125815 A1
(43) Pub. Date: May 20, 2010

(54) GESTURE-BASED CONTROL METHOD FOR INTERACTIVE SCREEN CONTROL

(76) Inventors: Ming-Jen Wang, Taichung City (TW); Kuen-Meau Chen, Miaoli City (TW)

Correspondence Address: CHRISTIE, PARKER & HALE, LLP, PO BOX 7068, PASADENA, CA, 91109-7068, US

(21) Appl. No.: 12/424,380

(22) Filed: Apr. 15, 2009

(30) Foreign Application Priority Data
Nov. 19, 2008 (TW) 097144686

(51) Int. Cl. G06F 3/033; G06F 3/048

(52) U.S. Cl. 715/856; 715/863

(57) ABSTRACT

A gesture-based control method for interactive screen control includes configuring an image-capturing module to capture a sequence of images of a gesture, configuring an analyzing module to determine whether the images captured by the image-capturing module match a predefined gesture corresponding to a function of an input device, and when it is determined that the images captured by the image-capturing module match the predefined gesture, configuring a processing module to perform an operation associated with the corresponding function of the input device and to control an interactive screen to show a result of the operation performed thereby.

### CROSS-REFERENCE TO RELATED APPLICATION

This application claims priority of Taiwanese Application No. 097144686, filed on Nov. 19, 2008.

### BACKGROUND OF THE INVENTION

1. Field of the Invention

This invention relates to a control method for interactive screen control, more particularly to a gesture-based control method for interactive screen control.

2. Description of the Related Art

A conventional input device, such as a computer mouse or a computer keyboard, may be used to control an interactive screen. The conventional input device, however, is bulky and is thus inconvenient to carry. Therefore, various conventional control methods for interactive screen control that eliminate the use of the conventional input device have been proposed. In one conventional control method, voice commands are issued to control an interactive screen. This conventional voice-based control method, however, is not applicable for those who have speech impairment. In another conventional control method, which employs the augmented reality (AR) technology, gestures are detected such as by a camera to control an electrical appliance. For example, when a first predefined gesture, such as extending a finger, is detected, and when an operation associated with the first predefined gesture is turning on the electrical appliance, the electrical appliance is turned on, and when a second predefined gesture, such as extending a pair of fingers, and when an operation associated with the second predefined gesture is turning off the electrical appliance, the electrical appliance is turned off. The aforementioned conventional gesture-based control method is disadvantageous in that different gestures are used for performing different operations to control the electrical appliance. That is, when turning on the electrical appliance, a gesture, i.e., the first predefined gesture, is made, and when turning off the electrical appliance, a different gesture, i.e., the second predefined gesture, is made. As a consequence, the user needs to memorize an indefinite number of predefined gestures in order to fully control the electrical appliance.

### SUMMARY OF THE INVENTION

Therefore, the object of the present invention is to provide a gesture-based control method for interactive screen control that can fully control an interactive screen using only a limited number of predefined gestures.

According to the present invention, a gesture-based control method for interactive screen control comprises configuring an image-capturing module to capture a sequence of images of a gesture, configuring an analyzing module to determine whether the images captured by the image-capturing module match a predefined gesture corresponding to a function of an input device, and when it is determined that the images captured by the image-capturing module match the predefined gesture, configuring a processing module to perform an operation associated with the corresponding function of the input device and to control an interactive screen to show a result of the operation performed thereby.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic perspective view of the preferred embodiment of a system according to this invention;

FIGS. 2 to 6 are schematic diagrams illustrating predefined gestures stored in the system in FIG. 1; and

FIG. 7 is a flow chart of the preferred embodiment of a gesture-based control method for interactive screen control according to this invention

### DETAILED DESCRIPTION OF THE PREFERRED EMBODIMENT

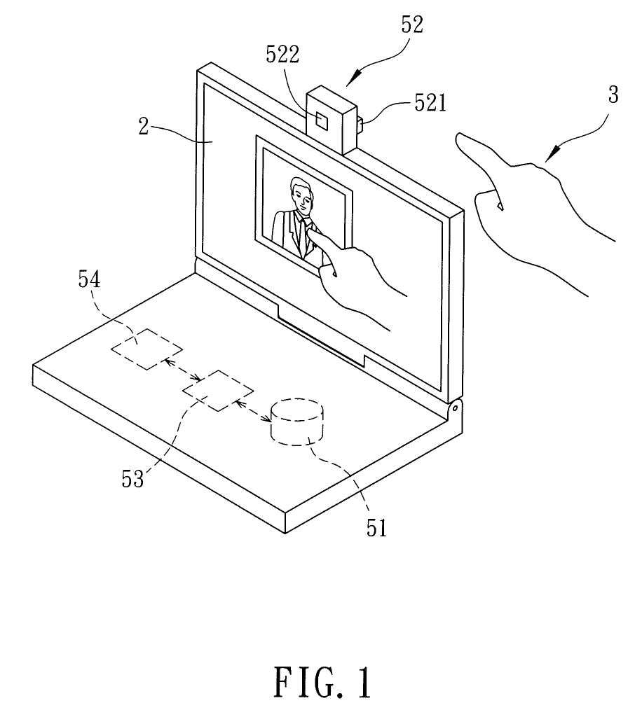

Referring to FIG. 1, the preferred embodiment of a system according to this invention includes a database 51, an image-capturing module 52, an analyzing module 53, and a processing module 54.

The database 51 stores therein a set of predefined gestures, namely, first, second, third, fourth, and fifth predefined gestures, and corresponding functions of a computer mouse.

In an alternative embodiment, the database 51 stores therein a set of predefined gestures, and corresponding functions of one of a computer keyboard, a computer steering wheel, and a computer joystick.

In yet another embodiment, the predefined gestures and the corresponding functions of the computer mouse are stored in a storage device, such as a disk drive.

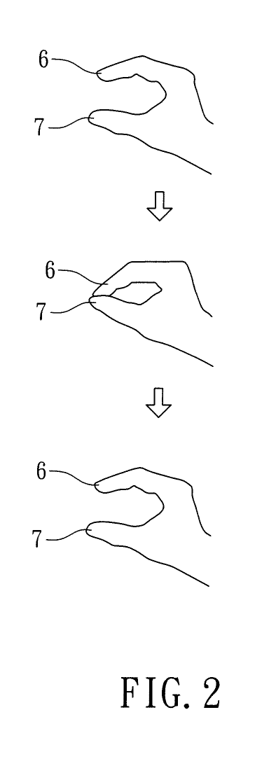

The first predefined gesture is assigned with a single-click function of a computer mouse. In this embodiment, the first predefined gesture is a pinch gesture made by a combination of an index finger and a thumb. That is, as illustrated in FIG. 2, the index finger 6 and the thumb 7 are first disposed at a spread apart position, where the index finger 6 and the thumb 7 are spaced apart from each other. Then, the index finger 6 and the thumb 7 are disposed at a pinch position, where the tips of the index finger 6 and the thumb 7 are in contact. Thereafter, the index finger 6 and the thumb 7 are disposed back to the spread apart position.

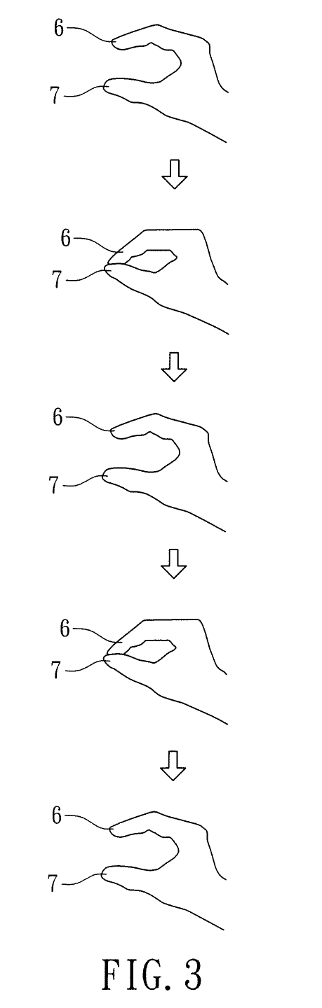

The second predefined gesture is assigned with a double-click function of a computer mouse. In this embodiment, the second predefined gesture is a double pinch gesture made by a combination of an index finger and a thumb. That is, as illustrated in FIG. 3, the index finger 6 and the thumb 7 make the pinch gesture twice.

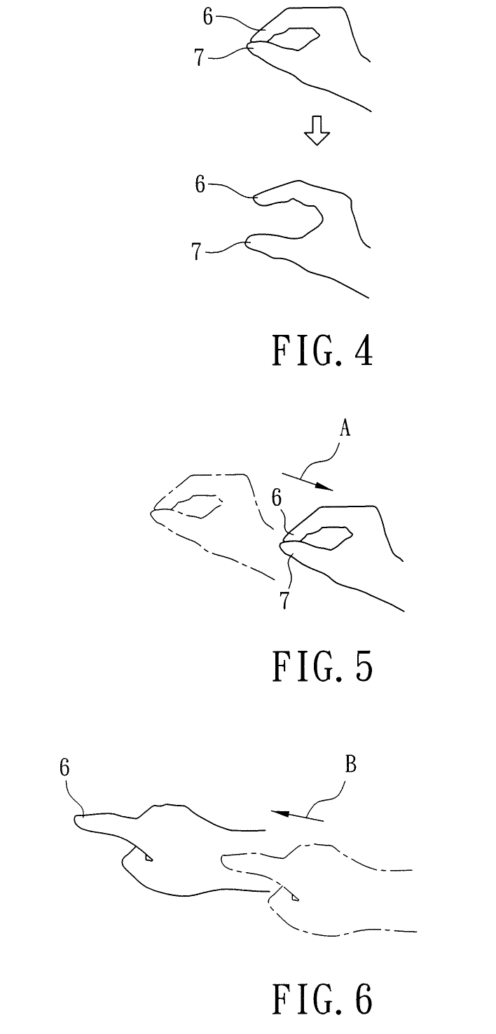

The third predefined gesture is assigned with a select function of a computer mouse. In this embodiment, the third predefined gesture is a spread gesture made by a combination of an index finger and a thumb. That is, as illustrated in FIG. 4, the index finger 6 and the thumb 7 are first disposed at the pinch position, and then at the spread apart position.

The fourth predefined gesture is assigned with a click-and-drag function of a computer mouse. In this embodiment, the fourth predefined gesture is a pinch-and-point gesture made by a combination of an index finger and a thumb. That is, as illustrated in FIG. 5, the index finger 6 and the thumb 7 are first disposed at the pinch position, and are then moved in a direction indicated by the arrow (A).

The fifth predefined gesture is assigned with a function of a computer mouse for moving a cursor. In this embodiment, the fifth predefined gesture is a point gesture made by an index finger. That is, as illustrated in FIG. 6, the index finger 6 is moved in a direction indicated by the arrow (B).

The image-capturing module 52 includes a lens unit 521 that captures a sequence of images such as of a gesture made by a hand 3, and a converter 522 that converts the images captured by the lens unit 521 into a digital format.

The system, such as notebook computer, further includes a display module 2 on which a computer-generated graphics, i.e., an interactive screen, and a real-world element, i.e., the images captured by the lens unit 521 of the image-capturing module 52, are displayed.

The analyzing module 53 is connected to the database 51 and the image-capturing module 52, and determines whether the images captured by the lens unit 521 of the image-capturing module 52 match one of the predefined gestures stored in the database 51.

For example, the analyzing module 53 first analyzes the images captured by the lens unit 521 of the image-capturing module 52, and then compares the images captured by the lens unit 521 of the image-capturing module 52 with the predefined gestures stored in the database 51. When the analyzing module 53 determines that the images captured by the lens unit 521 of the image-capturing module 52 match the second predefined gesture stored in the database 51, the analyzing module 53 generates a result that corresponds to the double-click function of a computer mouse.

The processing module 54 is connected to the analyzing module 53, and performs an operation based on the result generated by the analyzing module 53. In particular, as in the example above, the processing module 54 performs an operation associated with the double-click function of a computer mouse and controls the interactive screen to show a result of the operation performed thereby.

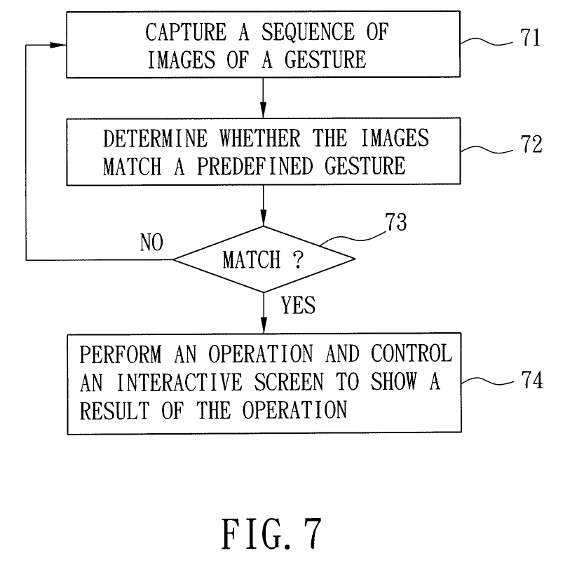

The preferred embodiment of a gesture-based control method for interactive screen control to be implemented using the aforementioned system according to this invention will now be described with further reference to FIG. 7.

In step 71, the lens unit 521 of the image-capturing module 52 is configured to capture a sequence of images of a gesture, and the converter 522 of the image-capturing module 52 is configured to convert the images captured by the lens unit 521 of the image-capturing module 52 into a digital format.

In step 72, the analyzing module 53 is configured to determine whether the images captured in step 71 match one of the predefined gestures.

In step 73, when it is determined in step 72 that the images captured in step 71 match one of the predefined gestures, the flow proceeds to step 74. Otherwise, the flow goes back to step 71.

In step 74, the processing module 54 performs an operation associated with a function of a computer mouse that corresponds to the matching one of the predefined gestures and controls an interactive screen to show a result of the operation performed thereby.

It has thus been shown that the gesture-based control method of this invention uses predefined gestures, each of which corresponds to a function of an input device, i.e., a computer mouse. As such, the same gesture may be made to perform different operations to control an interactive screen. For example, when performing different operations to control, such as to minimize, maximize, or close, an interactive screen, such as a window, the cursor is first moved to the corresponding button of the window using the fifth predefined gesture and then single-click the corresponding button of the window using the first predefined gesture. That is, for the three different operations, the same succession of the fifth and first predefined gestures is made. The gesture-based control method of this invention, therefore, only requires the user to memorize a limited number of predefined gestures in order to fully control an interactive screen.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A gesture-based control method for interactive screen control, comprising:
A) configuring an image-capturing module to capture a sequence of images of a gesture;
B) configuring an analyzing module to determine whether the images captured in step A) match a predefined gesture corresponding to a function of an input device; and
C) when it is determined in step B) that the images captured in step A) match the predefined gesture, configuring a processing module to perform an operation associated with the corresponding function of the input device and to control an interactive screen to show a result of the operation performed thereby.

2. The gesture-based control method as claimed in claim 1, wherein the input device is one of a computer mouse, a computer keyboard, a computer steering wheel, and a computer joystick.

3. The gesture-based control method as claimed in claim 1, wherein the predefined gesture is assigned with a function of a computer mouse for moving a cursor.

4. The gesture-based control method as claimed in claim 3, wherein the predefined gesture is a point gesture.

5. The gesture-based control method as claimed in claim 4, wherein the predefined gesture is a gesture made by an index finger.

6. The gesture-based control method as claimed in claim 1, wherein the predefined gesture is assigned with a single-click function of a computer mouse.

7. The gesture-based control method as claimed in claim 6, wherein the predefined gesture is a pinch gesture.

8. The gesture-based control method as claimed in claim 7, wherein the predefined gesture is a gesture made by a combination of an index finger and a thumb.

9. The gesture-based control method as claimed in claim 1, wherein the predefined gesture is assigned with a double-click function of a computer mouse.

10. The gesture-based control method as claimed in claim 9, wherein the predefined gesture is a double-pinch gesture.

11. The gesture-based control method as claimed in claim 10, wherein the predefined gesture is a gesture made by a combination of an index finger and a thumb.

12. The gesture-based control method as claimed in claim 1, wherein the predefined gesture is assigned with a select function of a computer mouse.

13. The gesture-based control method as claimed in claim 12, wherein the predefined gesture is a spread gesture.

14. The gesture-based control method as claimed in claim 13, wherein the predefined gesture is a gesture made by a combination of an index finger and a thumb.

15. The gesture-based control method as claimed in claim 1, wherein the predefined gesture is assigned with a click-and-drag function of a computer mouse.

16. The gesture-based control method as claimed in claim 15, wherein the predefined gesture is a pinch-and-point gesture.

17. The gesture-based control method as claimed in claim 16, wherein the predefined gesture is a gesture made by a combination of an index finger and a thumb.

18. The gesture-based control method as claimed in claim 1, wherein the predefined gesture and the corresponding function of the input device are stored in one of a database and a storage device.

19. The gesture-based control method as claimed in claim 1, wherein step A) includes the sub-step of configuring the image-capturing module to convert the images captured thereby into a digital format.

20. The gesture-based control method as claimed in claim 1, wherein, in step B), the analyzing module generates a result that corresponds to the function of the input device, and in step C), the operation performed by the processing module is based on the result generated by the analyzing module.
